(19) United States
(12) Patent Application Publication
(10) Pub. No.: US 2006/0002321 A1
(43) Pub. Date: Jan. 5, 2006

(54) Method and device for decreasing dissipation of power in receiver of digital multimedia broadcasting system

(75) Inventors: Geum-Goo Han, Hwaseong-si (KR); Kyung-Ha Lee, Seongnams-si (KR); Il-Ho Lee, Dong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/152,696

(22) Filed: Jun. 14, 2005

(30) Foreign Application Priority Data
Jun. 14, 2004 (KR) 2004-43759

(51) Int. Cl. H04J 3/24

(52) U.S. Cl. 370/312

(57) ABSTRACT

Disclosed is a method and a device for receiving broadcasting service in a digital multimedia broadcasting system which provides the broadcasting service through a first radio path and a second radio path, in which the first radio path allows only digital multimedia broadcasting service to be received therethrough and the second radio path allows the digital multimedia broadcasting service and mobile communication service to be received therethrough, the method including updating information about a received signal input through the radio paths, determining whether the second radio path is switched on, determining a reason when the second radio path is switched off why it is switched off; comparing the information about the received signal with corresponding predetermined threshold values depending on a result of the determination of why the second radio path is switched off; and resetting the second radio path as ‘off’.

### PRIORITY

This application claims priority under 35 U.S.C. 119(a) to an application entitled “Method And Device For Decreasing Dissipation Of Power In Receiver Of Digital Multimedia Broadcasting System” filed in the Korean Intellectual Property Office on Jun. 14, 2004 and assigned Ser. No. 2004-43759, the contents of which are incorporated herein by reference.

### BACKGROUND OF THE INVENTION

1. Field of the Invention

The present invention relates to a method and a device for decreasing dissipation of power in a wireless communication system, and more particularly to a method and a device for minimizing dissipation of power in a receiver of a digital multimedia broadcasting system to which antenna diversity is applied.

2. Description of the Related Art

Digital multimedia broadcasting (DMB) is based on digital radio broadcasting, i.e., digital audio broadcasting (DAB), which became available in the late 1980's. DAB is one of the most widely developed types of radio broadcasting. DMB uses digital techniques which have been developed since the early 1980's. Today DAB development continues at a brisk pace as it has become possible to transmit data regardless of the program format.

A recently introduced media “DMB”, can transmit images using a digital radio frequency band for the digital radio.

Meanwhile, DMB can be classified into “terrestrial DMB”, and “satellite DMB”. Terrestrial DMB currently uses the same frequency band as that which is used for conventional television transmission (TV), e.g., a frequency band of 174 to 216 MHz and therefore can utilize existing TV transmission and relay stations. In contrast, satellite DMB uses a high frequency band for transmission (e.g., 2605 to 2655 MHz). A service provider of a terrestrial DMB uses a frequency bandwidth of 1.54 MHz to transmit, while a, service provider of a satellite DMB uses a frequency bandwidth of 25 MHz. Satellite DMB uses a greater frequency bandwidth than that used in the terrestrial DMB. For example, accordingly, terrestrial DMB can simultaneously provide an image channel and approximately three audio/data channels, and satellite DMB can simultaneously provide 10 to 12 image channels and approximately 30 audio/data channels. Satellite DMB focuses on receiving satellite digital multimedia broadcasting service, using a terminal which is similar in size to that of a conventional portable telephone (e.g. cellular telephone). Accordingly, satellite DMB can be classified as a type of mobile broadcasting media.

Currently, satellite DMB techniques are being developed. Specifically, a satellite DMB terminal using a 2.6 GHz band is under development. Because DMB terminals can simultaneously receive a plurality of data channels, DMB terminals consume a more power than existing terrestrial communication systems, thereby decreasing battery life and degrading reception.

### SUMMARY OF THE INVENTION

Accordingly, the present invention has been made to solve the above-mentioned problems occurring in the prior art, and an object of the present invention is to provide a method and device for decreasing the dissipation of power in a terminal receiver (TR) of a satellite digital multimedia broadcasting system.

Another object of the present invention is to provide a method and a device for decreasing dissipation of power in a terminal receiver of a satellite digital multimedia broadcasting system including a rake receiver and to which antenna diversity is applied.

To accomplish these and other objects, in accordance with one aspect of the present invention, there is provided a method for receiving broadcasting service in a digital multimedia broadcasting system which provides the broadcasting service through a first radio path and a second radio path, in which the first radio path allows only digital multimedia broadcasting service to be received therethrough and the second radio path allows the digital multimedia broadcasting service and a mobile communication service to be received therethrough, the method including the steps of updating information about a received signal input through the radio paths determining whether the second radio path of the radio paths is switched on and/or off; determining a reason of an off state of the second radio path when the second radio path is switched off, comparing the information about the received signal with corresponding predetermined threshold values depending on a result of the determination of the reason why the second radio path is switched off, and resetting the second radio path as “off” when all the information about the received signal are greater than the corresponding predetermined threshold values, respectively.

In accordance with another aspect of the present invention, there is provided a device for receiving broadcasting service in a digital multimedia broadcasting system which provides the broadcasting service through a first radio path and a second radio path, in which the first radio path allows only digital multimedia broadcasting service to be received therethrough and the second radio path allows the digital multimedia broadcasting service and a mobile communication service to be received therethrough, the device including antennas for receiving a digital multimedia broadcasting signal; an analog-to-digital converter (ADC) for receiving the signal received through by antennas through the first radio path or second radio path, receiving an intensity of the received signal, and then outputting a digital signal, a rake receiver for measuring and outputting a signal-to-noise ratio of the signal output from the analog-to-digital converter; a channel codec for measuring a bit error rate of the signal output from the rake receiver, and demodulating, decoding and outputting the signal output from the rake receiver; and a central processing unit for updating information about a received signal by using the received signal intensity, the signal-to-noise ratio and the bit error rate, determining a reason of an off state of the second radio path of the radio paths when the second radio path is switched off, comparing the information about the received signal with corresponding predetermined threshold values depending on a result of the determination of the reason why the second radio path is switched off, and resetting the second radio path as “off” when all the information about the received signal are greater than the corresponding predetermined threshold values, respectively.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a terminal receiver employing antenna diversity in a satellite digital multimedia broadcasting (DMB) system according to an embodiment of the present invention; and

FIG. 2 is a flowchart illustrating an operation of the terminal receiver having decreased power consumption according to an embodiment of the present invention.

### DETAILED DESCRIPTION OF THE PREFERRED EMBODIMENT

Hereinafter, a preferred embodiment according to the present invention will be described with reference to the accompanying drawings. In the following description of the embodiments of the present invention, a detailed description of known functions and configurations incorporated herein will be omitted when it may obscure the subject matter of the present invention.

In the present invention, power consumption of a terminal receiver is minimized to maintain its optimum reception performance of the terminal receiver and a rake receiver is utilized in a Code Division Multiplexing (CDM) scheme to use antenna diversity.

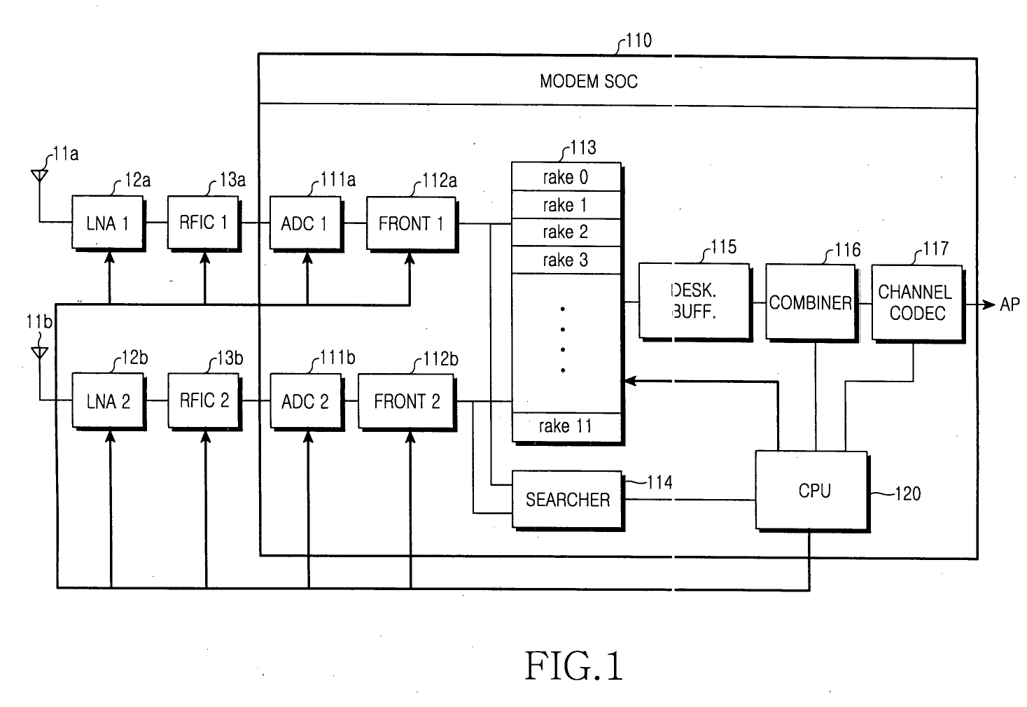

A block diagram illustrating a configuration of a terminal receiver employing antenna diversity in a satellite digital multimedia broadcasting (DMB) system according to an embodiment of the present invention is shown in FIG. 1.

Signals received through each of antennas 11a and 11b pass through low-noise amplifiers (LNAs) 12a and 12b and radio frequency integrated circuits (RFICs) 13a and 13b, respectively, and are then input to a modem unit 110. From among the antennas, a first antenna 11a can receive only satellite DMB service, and a second antenna 11b has a dual mode function and can receive satellite DMB service and conventional mobile communication service capable of using a rake and searcher such as CDMA or WCDMA. In the following description, a path through which a signal received by the first antenna passes is known as a “first path” and a path through which a signal received through the second antenna passes is known as a “second path”.

The modem unit 110 includes analog-to-digital converters 111a and 111b, fronts 112a and 112b, a rake receiver 113, a searcher 114, a buffer (desk buffer) 115, a combiner 116, a channel codec 117.

Radio frequency (RF) signals output from the radio frequency integrated circuits 13a and 13b are input to the analog-to-digital converters 111a and 111b, and are converted into digital signals, respectively. The converted digital signals pass through the fronts 112a and 112b functioning as digital filters, respectively, and then are input to both of the rake receiver 113 and the searcher 114. Although it is not shown, the radio frequency integrated circuits 13a and 13b and the analog-to-digital converters 111a and 111b include automatic gain control (AGC) loops. The AGC loops are used to measure the intensities of signals received through the antennas 11a and 11b. A signal output from the rake receiver 113 is stored in the buffer 115 and is then input to the combiner 116 so as to be combined. The combined signal is input to the channel codec 117. The channel codec 117 includes a bit deinterleaver, a Viterbi decoder, a byte deinterleaver and a Reed-Solomon decoder (which are not shown for the sake of clarity). A signal encoded by the channel codec 117 is output to an application processor (AP) (not shown).

The modem includes a central processing unit (CPU) 120 for controlling the rake receiver 113. The central processing unit 120 periodically checks receiver parameters including a post automatic gain control (AGC) received signal strength identifier (RSSI), a searcher and rake signal-to-noise ratio (search & rake Ec/Io), a post Viterbi bit error rate (BER), etc., according to a timer signal provided from an operating system (OS) in the CPU, a dump signal of the searcher 114, a decoder interrupt signal and the like. Herein, the dump signal of the searcher 114 represents an interrupt signal generated by the CPU when a signal search is finished in the modem 110, and the decoder interrupt signal is generated after (RS) Reed-Solomon decoding is finished. The post AGC RSSI represents the magnitudes of analog signals input to the analog-to-digital converters 111a and 111b, and the searcher and rake signal-to-noise ratio represents the intensity of a desired signal from among signals input into the searcher 114 and rake receiver 113.

The central processing unit 120 outputs on/off control signals to the low-noise amplifiers 12a and 12b, the radio frequency integrated circuits 13a and 13b, the fronts 112a and 112b and the analog-to-digital converters 111a and 111b, etc.

Hereinafter, a method for decreasing dissipation of power in the terminal receiver having the above-mentioned configuration will be described. The method for decreasing the dissipation of power includes switching off any one path of the two radio paths when the terminal receiver is in a weak or strong electric field. For example, if it is determined that the second radio path should be shut off, then any element in the second radio path can be shut off e.g., the low-noise amplifier 12b, the radio frequency integrated circuit 13b and/or elements such as the modem 110 included in the second path, in a weak or strong electric field, the front 112b, the analog-to-digital converter 111b and at least one half or more of the rake receiver 113 which are included in the second path. If the determination is made to shut off the second path, them selected elements in the second path can be turned off.

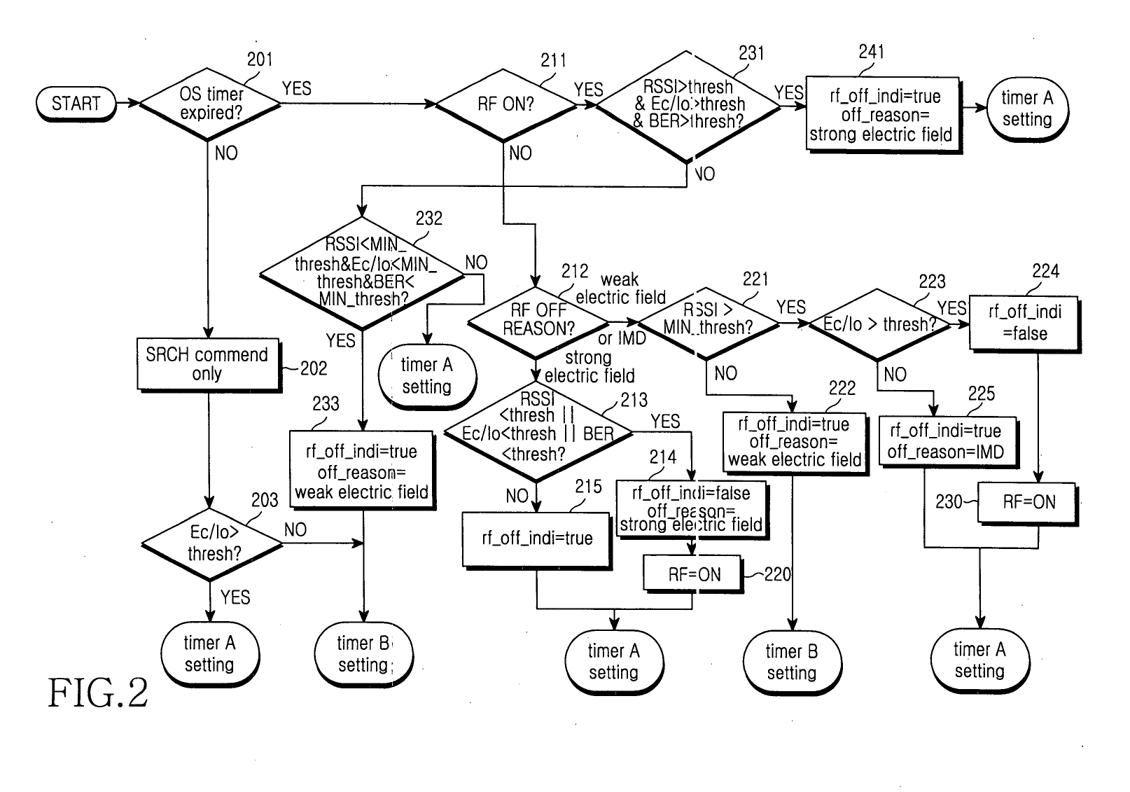

FIG. 2 is a flowchart illustrating an operation of the terminal receiver having a decreased power consumption according to an embodiment of the present invention.

In order to decrease power consumption of the terminal receiver, the central processing unit 120 updates and stores a signal-to-noise ratio (Ec/Io) using information about a received signal strength indicator (RSSI) from the searcher 114 and rake receiver 113 for each of the received signals whenever a search dump interrupt is generated in the search dump interrupt is generated by the modem unit 110 according to a predetermined operating scheme., When a channel decoder interrupt is generated, the central processing unit 120 updates and stores a bit error rate (BER)When a timer signal “RSSI_Timer” provided by the OS is generated, the central processing unit 120 checks and updates an AGC RSSI, and then checks radio-path-off indicator (rf_off_indicator) information so as to determine whether the second radio path (RF2) is switched on or off. Herein, the “rf_off_indicator” represents an indicator existing in a software code which indicates a “false” when the circuit of the second path (RF2) is switched on and indicates a “true” when the circuit of the second path (RF2) is switched off.

In step 201, the central processing unit 120 determines whether an OS timer has expired. When the timer has not expired, proceeds to step 202. In step 202, the central processing unit 120 performs a control operation so that the searcher 114 may perform an searching operation. Thereafter, the central processing unit 120 compares a signal-to-noise ratio (Ec/Io) for a received signal from antenna 11a with a predetermined threshold value. As a result, when the signal-to-noise ratio is greater than the predetermined threshold value, the central processing unit 120 sets timer A. In contrast, when the signal-to-noise ratio is smaller than the predetermined threshold value, the central processing unit 120 sets timer B.

Meanwhile, as a result of step 201, when the OS timer has expired, proceeds to step 211. In step 211, the central processing unit 120 checks the “rf_off_indicator” and determines whether the second path (RF2) is switched on or off. As a result of the determination, in step 212, when the second path is switched off, the central processing unit 120 checks radio-path-off-reason indicator “rf_off_reason_indicator” information and determines why the second path is switched off. Herein, the “rf_off_reason_indicator” represents an indicator existing in a software code, which indicates why the second path is switched off. For example, the second path may be switched off because of a strong electric field, a weak electric field, inter-modulation distortion (IMD) and a middle electric field (electric status in the middle between a weak electric field and a strong electric filed). In the case of a middle electric field, the central processing unit 120 switches off a smaller portion of the circuit than that which is switched off in the cases of a strong electric field and a weak electric field.

In step 213 when the second path is switched off because of a strong electric field, that is, when the “rf_off_reason_indicator” indicates a strong electric field, the central processing unit 120 checks an AGCI RSSI, an Ec/Io and a BER for a received signal from antenna 11a and compares each of the checked values with a corresponding predetermined threshold value in step 213. As a result of the comparison, when any one of the checked values fails to exceed its corresponding threshold value, the “rf_off_indicator” is set as “false” and the “rf_off_reason_indicator” is set as a “strong electric field” in step 214. Thereafter, in step 220, the central processing unit 120 switches on the second path and that portion of the modem, which has been switched off, and then sets timer A. In contrast, as a result of the comparison in step 213, when all the checked values exceed their corresponding threshold values, the central processing unit 120 continues to step 215 and sets the “rf_off_indicator” to “true” state, and then sets timer A.

Meanwhile, as a result of step 212, when the second path is switched off due to a weak electric field or to inter-modulation distortion (IMD), the central processing unit 120 proceeds to step 221, in which the central processing unit 120 checks the AGC1 RSSI and compares the checked value with a minimum threshold value (MIN_thresh) for a received signal from antenna 11a. When the AGC RSSI is smaller than the minimum threshold value, the central processing unit 120 stops searching during a predetermined time interval, sets the “rf_off_indicator” and “rf_off_reason_indicator” as “true” and “weak electric field”, respectively, in step 222, and then sets timer B.

In contrast, as a result of comparison in step 221, when the AGC RSSI is greater than the minimum threshold value, the central processing unit 120 proceeds to step 223 in which the central processing unit 120 compares a signal-to-noise ratio (Ec/Io) for a received signal from antenna 11a with a threshold value. As a result of the comparison, when the signal-to-noise ratio is greater than the threshold value, the central processing unit 120 sets the “rf_off_indicator” as “false” in step 224, and switches on that portion of the modem which has been previously switched off, in step 230 and then sets timer A. In contrast, as a result of the comparison in step 223, when the signal-to-noise ratio is smaller than the threshold value (which represents that the second path is at an IMD state), the central processing unit 120 sets the “rf_off_indicator” and “rf_off_reason_indicator” to ‘true’ and ‘IMD’, respectively, in step 225, and then sets timer A.

Meanwhile, as a result of the determination in step 211, when the second path is switched on, the central processing unit 120 proceeds to step 231, in which the central processing unit 120 compares values of an AGC RSSI, an Ec/Io and a BER with corresponding threshold values for a received signal from antenna 11a. As a result of the comparison, when any one of the values is smaller than its corresponding threshold value, the central processing unit 120 compares the three values with corresponding minimum threshold values in step 232. As a result of the comparison in step 232, when all of the three values are smaller than the corresponding minimum threshold values, respectively (which represents that the second path is at a “weak electric field” state), the central processing unit 120 proceeds to step 233. In step 233, the central processing unit 120 sets the “rf_off_indicator” and “rf_off reason_indicator” as “true” and “weak electric field”, electric field’, respectively, and then sets timer B. In contrast, as a result of the determination step 232, when all the three values are greater than the corresponding minimum threshold values, the central processing unit 120 sets timer A.

Meanwhile, as a result of step the comparison in 231, when all the values of the AGC RSSI, the Ec/Io and the BER are greater than the corresponding threshold values, (which represents that the second path is at a “strong electric field” state), the central processing unit 120 proceeds to step 241. In step 241, the central processing unit 120 sets the “rf_off_indicator” and “rf_off_reason_indicator” as “true” and a “strong electric field”, respectively, and then sets timer A.

According to the embodiment of the present invention, the terminal receiver of a satellite DMB system includes a rake receiver and employs antenna diversity so as to switch off one of radio paths, so that it is possible to decrease power consumption, thereby further improving the terminal receiver's reception.

While the present invention has been shown and described with reference to certain preferred embodiments thereof, it will be understood by those skilled in the art that various changes in form and detail may be made therein without departing from the spirit and scope of the invention as defined by the appended claims. Accordingly, the scope of the invention is not to be limited by the above embodiments but by the claims and the equivalents thereof.

What is claimed is:

1. A method for receiving broadcasting service in a digital multimedia broadcasting system, the method comprising the steps of:
updating information about a received signal input through radio paths;
comparing the information about the received signal with corresponding predetermined threshold values depending on a result of determination of a reason why the second radio path is switched off; and
resetting the second radio path as “off’ when the information about the received signal is greater than the corresponding predetermined threshold values.

2. The method as claimed in claim 1, wherein the reason why the second radio path is switched off is a strong electric field.

3. The method as claimed in claim 1, further comprising determining whether a received signal intensity from the information about the received signal is greater than a corresponding predetermined minimum threshold value, when the reason why the second radio path is switched off is a weak electric field.

4. The method as claimed in claim 3, further comprising setting a state of the second radio path as “true” and setting the reason why the second radio path is switched off to “weak electric field”, when the received signal intensity is less than or equal to than the predetermined minimum threshold value.

5. The method as claimed in claim 4, further comprising the steps of:
determining whether a signal-to-noise ratio from the information about the received signal is greater than a corresponding predetermined threshold value, when the received signal intensity is greater than the predetermined minimum threshold value;
setting the state of the second radio path as “false”, when the signal-to-noise ratio from the information about the received signal is greater than the predetermined threshold value; and
setting the state of the second radio path to “on”.

6. The method as claimed in claim 5, wherein, when the signal-to-noise ratio from among the information about the received signal is less than or equal to the predetermined threshold value, the state of the second radio path is set to “true”, and the reason why the second radio path is switched off is set to “inter-modulation distortion (IMD)”.

7. The method as claimed in claim 1, wherein, when at least one of the information about the received signal is less than a corresponding predetermined threshold value, the state of the second radio path is set as “false”, and the reason why the second radio path is switched off is set to a “strong electric field”.

8. The method as claimed in claim 1, further comprising the steps of:
comparing the information about the received signal with the corresponding predetermined threshold values when the second radio path is in an “on” state; and
resetting the second radio path as ‘off’ when all the information about the received signal is greater than the corresponding predetermined threshold values.

9. The method as claimed in claim 8, wherein in the step of resetting the second radio path to “off”, the state of the second radio path is set to “true” and the reason why the second radio path is switched off is set to a “strong electric field”.

10. The method as claimed in claim 1, wherein the information about the received signal includes a received signal intensity, a signal-to-noise ratio and a bit error rate.

11. A device for receiving broadcasting service in a digital multimedia broadcasting system, the device comprising:
a plurality of antennas for receiving a digital multimedia broadcasting signal;
an analog-to-digital converter for receiving the signal received through a first radio path or a second radio path, receiving a signal intensity of the received signal, and then outputting a corresponding digital signal;
a rake receiver for measuring and outputting a signal including a signal-to-noise ratio of the digital signal output from the analog-to-digital converter;
a channel codec for measuring a bit error rate of the signal output from the rake receiver, and demodulating, decoding and outputting the signal output from the rake receiver; and
a central processing unit for updating information about a received signal using the received signal intensity, the signal-to-noise ratio and the bit error rate of the signal, comparing the information about the received signal with corresponding predetermined threshold values depending on a result of determination of a reason why the second radio path is switched off, and resetting the second radio path as “off” when all the information about the received signal are greater than the corresponding predetermined threshold values, respectively

12. The device as claimed in claim 11, wherein the the reason why the second radio path is switched off is a strong electric field.

13. The device as claimed in claim 11, wherein the central processing unit determines whether the received signal intensity from among the information about the received signal is greater than a predetermined minimum threshold value, when the reason why the second radio path is switched off is a weak electric field.

14. The device as claimed in claim 13, wherein the central processing unit sets a state of the second radio path to “true” and sets the reason why the second radio path is switched off to a “weak electric field”, when the received signal intensity is less than or equal to the predetermined minimum threshold value.

15. The device as claimed in claim 14, wherein the central processing unit determines whether the signal-to-noise ratio from among the information about the received signal is greater than a predetermined threshold value when the received signal intensity is greater than the predetermined minimum threshold value, and sets the state of the second radio path to “false” and sets the the second radio path to “on” when the signal-to-noise ratio from among the information about the received signal is greater than the predetermined threshold value.

16. The device as claimed in claim 15, wherein, when the signal-to-noise ratio from among the information about the received signal is less than or equal to the predetermined threshold value, the central processing unit sets the state of the second radio path to “true” and sets the reason why the second radio path is switched off to “inter-modulation distortion (IMD)”.

17. The device as claimed in claim 11, wherein, when at least one of the information about the received signal is less than its corresponding predetermined threshold value, the central processing unit sets the state of the second radio path to “false”, and sets the reason why the second radio path is switched off to a “strong electric field”.

18. The device as claimed in claim 11, wherein the central processing unit compares the information about the received signal with the corresponding predetermined threshold values when the second radio path is in an “on” state, and resets the second radio path to “off” when all the information about the received signal are greater than the corresponding predetermined threshold values, respectively.

19. The device as claimed in claim 18, wherein the central processing unit sets the state of the second radio path to “true” and sets the reason why the second radio path is switched off to a “strong electric field” when resetting the second radio path to “off”.
